(19) United States
(12) Patent Application Publication
(10) Pub. No.: US 2002/0067501 A1
(43) Pub. Date: Jun. 6, 2002

(54) PRINT DATA CONTROL SYSTEM

(76) Inventor: MASAKI WATANABE, TOKYO (JP)

Correspondence Address: FOLEY & LARDNER, 3000 K STREET NW, SUITE 500, PO BOX 25696, WASHINGTON, DC, 200078696

(21) Appl. No.: 09/174,551

(22) Filed: Oct. 19, 1998

(30) Foreign Application Priority Data
Oct. 17, 1997 (JP) 285363/1997

(51) Int. Cl. G06K 15/02; G06F 13/00

(52) U.S. Cl. 358/1.15

(57) ABSTRACT

In a network system composed of a plurality of computers, print data is divided into a plurality of sequential bands and then the sequential bands are distributed over available computers. at each of the available computers, a received band is expanded to bit-map band data. The bit-map band data are combined according to the original sequence to produce bit-map data for printing corresponding to the print data.

### BACKGROUND OF THE INVENTION

1. Field of the invention

The present invention generally relates to a network system composed of a plurality of computers and a printer, and in particular to system and method for processing and transferring data from a computer to the printer.

2. Description of the Related Art

There have been proposed several methods which expands print data generated by an application to bit-map data for printer at a high speed, For example, a printing system composed of a host computer and a printer has been disclosed in Japanese Patent Unexamined Publication No. 9-6552. According to this conventional printing system, a page of data is divided into a plurality of bands at the host computer. The first top band is expanded to first bit-map data at the host computer and the second top band is transferred from the host computer to the printer. The first bit-map data expanded at the host computer is transferred to the printer where the first bit-map data is printed while the second top band received from the host computer is expanded in parallel. Alternatively, while expanding the first top band at the host computer, the following bands are transferred to the printer to be expanded. By repeatedly performing such data expanding and transferring at host computer and printer until the page of data has been printed, the printing performance of the host computer is improved.

However, in the conventional method, the parallel data expanding is performed between the host computer and the printer with a predetermined sequence. Therefore, in the case of a network system such as a client/server system composed of a print server and a plurality of client computers, there are cases where the maximum performance cannot be achieved. In the case where a client computer operates at higher speeds and a print server at lower speeds, for example, the client computer must wait until the data expanding process has been completed at the print server. This causes the printing performance of the system to be reduced on the whole.

### SUMMARY OF THE INVENTION

An object of the present invention is to provide print data control system and method which can achieve high-speed printing in a network system.

According to an aspect of the present invention, in a network system composed of a plurality of computers, print data is divided into a plurality of bands and then a sequentially selected one of the bands is transferred to an available one of at least two print data expanders each implemented in a computer. In each of the at least two print data expanders, a received band is expanded to bit-map band data, The bit-map band data expanded by the at least two print data expanders are combined to produce the bit-map data corresponding to the print data. Preferably, the print data is divided into sequential bands and thereby the bit-map band data expanded by the at least two print data expanders can be combined in original sequence.

According to another aspect of the present invention, in a network system composed of a print server computer and a plurality of client computers, print data is divided into a plurality of sequential bands, which are distributed over the print server computer and at least one client computer to expand the sequential bands to bit-map band data in parallel among the print server computer and at least one client computer. The bit-map band data are combined to produce the bit-map data corresponding to the print data.

According to still another aspect of the present invention, in a network system composed of a plurality of computers, the sequential bands are distributed over available computers to expand the sequential bands to bit-map band data in parallel among the available computers.

As described above, the bands obtained by dividing the print data are distributed over available computers to be expanded to bit-map data in parallel among them. Therefore, the parallel expanding operation can be efficiently performed in the computer network system such as client/server system, resulting in high-speed printing.

Further, since each of the bands is transferred to an available print data expander or computer, the hands are distributed over the computers taking into account the current burdens thereof. Therefore, a certain computer within the network system is prevented from being put under heavy load.

### BRIEF DESCRIPTION OF THE DRAWINGS

FIG. 1 is a schematic block diagram showing client/server system employing a print data control system according to a first embodiment of the present invention;

FIG. 2 is a detailed block diagram showing a circuit configuration of the print data control system according to the first embodiment;

FIG. 3 is a flow chart showing a control operation of a client computer;

FIG. 4 is a flow chart showing a control operation of a print server computer;

FIG. 5 is a block diagram showing client/server system employing a print data control system according to a second embodiment of the present invention;

FIG. 6 is a schematic block diagram showing a network system employing a print data control system according to a third embodiment of the present invention;

FIG. 7 is a detailed block diagram showing a circuit configuration of the print data control system according to the third embodiment;

FIG. 8 its a schematic block diagram showing the connection of a control program memory in the network system according to the first embodiment; and

FIG. 9 is a schematic block diagram showing the connection of a control program memory in the network system according to the third embodiment.

### DETAILED DESCRIPTION OF THE PREFERRED EMBODIMENTS

### First Embodiment

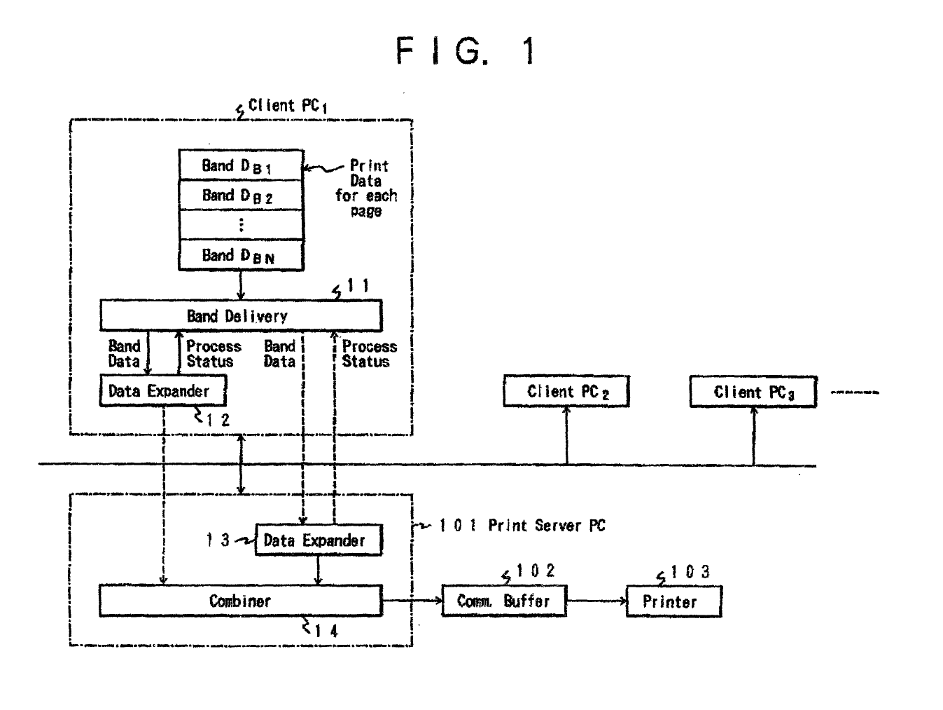

Referring to FIG. 1, a network system in composed of a print server computer 101 and a plurality of client computers PC₁, PC₂, . . . , wherein the print server computer 101 is connected to a printer 103 through a communication buffer 102. Each client computer is provided with a band delivery section 11 and a data expander 12. The print server computer 101 is provided with a data expander 13 and a combiner 14.

For example, when a print request occurs and print data is generated by an application in the client computer PC₁, print data for each page is horizontally divided into N bands D_{B1}-D_{BN} (N is an integer) which are numbered in sequence from the top of the page. The band delivery section 11 receives process statuses from the data expanders 12 and 13 and determines which one of the data expanders 12 and 13 should process each band depending on them. In other words, the band delivery section 11 distributes the sequential bands D_{B1}-D_{BN} over available data expanders.

The data expanders 12 and 13 output expanded band data to the combiner 14, which combines received band data so as to rearrange the received expanded band data in original sequence. The expanded data for each page is stored in a communication buffer 102 and then is printed by the printer 103.

In this manner, the print data for each page is expanded in bands at the client computer and the print server computer 101. More specifically, when a lot of band data to be expanded are received from a plurality of client computers, the print server computer 101 is burdened with a large amount of data to be processed, resulting in reduced processing speed. Contrarily, when the print server computer 101 is burdened with a small amount of data to be expanded, the print server computer 101 operates at very high speeds. In this way, a burden on the print server computer 101 varies depending on the operation states of the client computers.

Therefore, when the print server computer 101 is burdened with a large amount of data and the client computer is not occupied by another process, the print data would be expanded for the most part by the data expander 12 of the client computer. When the print server computer 101 is burdened with a small amount of data and the client computer is burdened with a lot of data to be processed, the print data would be expanded for the most part by the data expander 13 of the print server computer 101. The details will be described hereinafter.

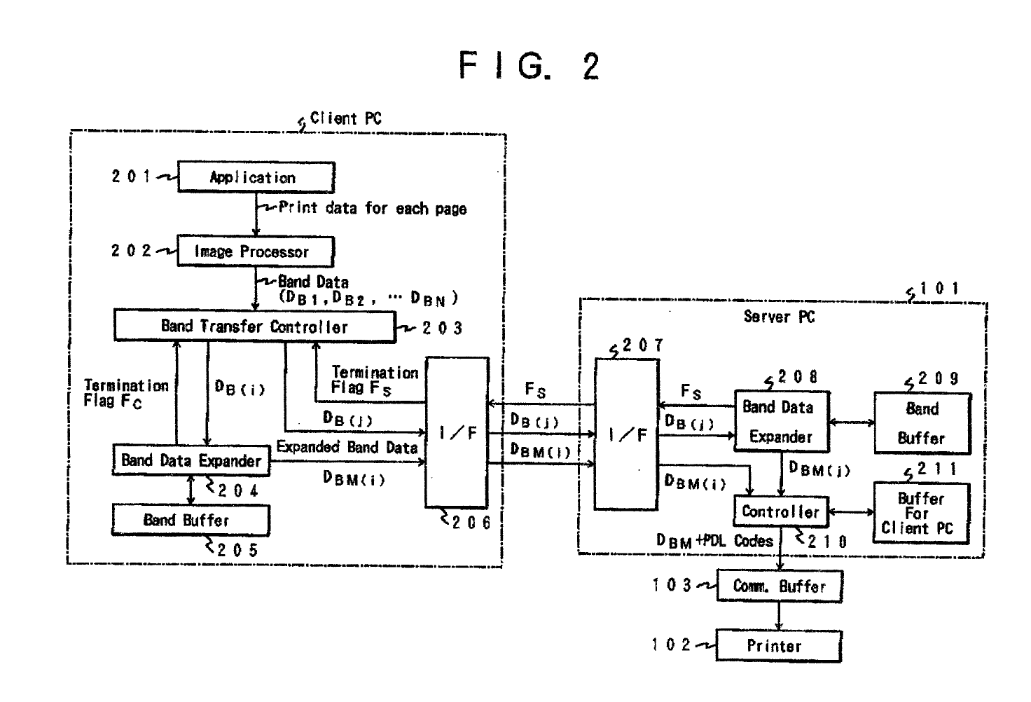

Referring to FIG. 2, assuming that print data is generated by an application 201 at a client computer PC. Print data for each page is output to an image processor 202, which divides the print data into data of N bands D_{B1}-D_{BN} which are numbered in sequence from the top of the page so as to allow the bands to be rearranged in original sequence.

When sequentially receiving the respective band data D_{B1}-D_{BN} from the image processor 202, a band transfer controller 203 determines which side should expand each received band into bit-map data depending on client termination flag F_{C} received from a band data expander 204 and server termination flag F_{S} received from the server computer 101. More specifically, when receiving the client termination flag F_{C} indicating the termination of data processing from the band data expander 204, the band transfer controller 203 transfers the data of a band D_{B(i)} with band number i to the band data expander 204. Similarly, when receiving the termination flag F_{S} indicating the termination of data processing from the server computer 101, the band transfer controller 203 transfers the data of a band D_{B(j)} with band number j to the server computer 101. In this manner, the sequential bands are distributed over available band data expanders.

When receiving the band data D_{B(i)} from the band transfer controller 203, the band data expander 204 expands the band data to bit-map data D_{BM(i)} for printing and stores it onto a band buffer 205. During the data expanding operation, the client termination flag F_{C} is reset. When the band data has been completely expanded, the band data expander 204 set the client termination flag F_{C} and sends it back to the band transfer controller 203.

Each client computer is provided with a predetermined interface circuit 206 to be connected to the network system. The bit-map data D_{BM(i)} and the band data D_{B(j)} are sent to the server computer 101 through a predetermined interface circuit 206. Further, the server termination flag F_{S} is received from the server computer 101 through the interface circuit 206.

The server computer 101 is provided with a predetermined interface circuit 207 through which the server termination flag F_{S} is sent to the client computer PC and the bit-map data D_{BM(i)} and the band data D_{B(j)} are received from the client computer PC.

The server computer 101 includes a band data expander 208 and a band buffer 209. When receiving the band data D_{B(j)} from the client computer PC, the band data expander 208 expands the band data to bit-map data DBASE) for printing and stores it onto the band buffer 209. During the data expanding operation, the server termination flag F_{S} is reset. When the band data has been completely expanded, the band data expander 208 sets the server termination flag F_{S} and sends it back to the band transfer controller 203 of the client computer PC.

The server computer 101 further includes a controller 210 and a bit-map data buffer 211 for storing client bit-map data received from the client computers. The controller 210 receives the bit-map data D_{MB(i)} from the client computer PC and the bit-map data D_{BN(j)} from the band data expander 208, which are stored onto the bit-map data butter 211 so that the bit-map data of bands are rearranged in original sequence by referring to the attached band numbers. More specifically, there is cases where the bit-map data D_{BM(i)} and the bit-map data D_{BM(j)} are not received in original sequence due to difference in speed between the client computer PC and the print server computer 101. Therefore, it is necessary to check the band number of each received bit-map data and thereby to rearrange the received bit-map data to reproduce the bit-map data for each page to be printed.

In other words, in the parallel banding, it is necessary to synchronize the client computer PC and the print server computer 101 with respect to banding process. For this, the bit-map data buffer 211 is provided to save the bit-map data D_{BM(i)} received from the client computer PC so as to prevent the lack of the necessary band data.

The controller 210 performs such rearrangement and further adds printer control codes of page description language (PDL) to the rearranged bit-map data for each page. In this way, the rearranged bit-map data with PDL codes is stored onto the communication buffer 103 and then is printed on the printer 102.

It should be noted that the image processor 202, the band transfer controller 203, and the band data expander 204 in each client computer could be implemented with a program-controlled processor running the equivalent client control program. Similarly, in the server computer 101, the band expander 208 and the controller 210 could be implemented with a program-controlled processor running the equivalent server control program,.

### Band Transfer Control

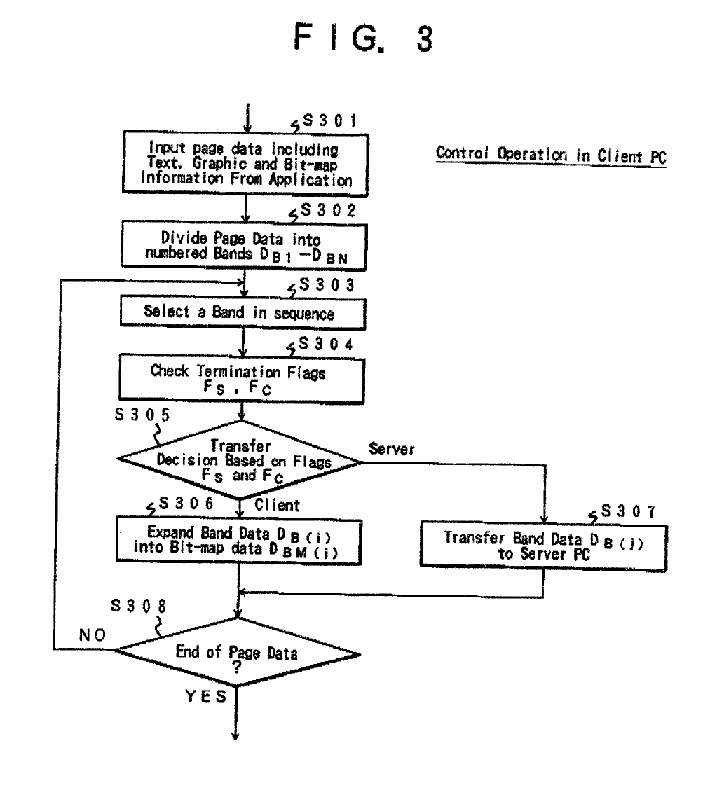

Referring to FIG. 3, when receiving page print data including text data, graphic data and bit-map information from the application 201 (step S301), the image processor 202 divides the page data into numbered bands D_{B1}-D_{BN} (step S302). The band transfer controller 203 inputs one of the bards D_{B1}-D_{BN} in sequence (step S303) and then checks the client termination flag F_{C} and the server termination flag F_{S} (step S304).

When the client termination flag Fc indicates the termination of data processing of the band data expander 204 (here, F_{C}=1), the band transfer controller 203 transfers the data of a band D_{B(i)} with band number i to the band data expander 204. When receiving the band data D_{B(i)} from the band transfer controller 203, the band data expander 204 expands the band data to bit-map data D_{BM(i)} for printing and stores it onto the band buffer 205 (step 306). During the data expanding operation, the client termination flag F_{C} is reset to 0. When the band data has been completely expanded, the band data expander 204 set the client termination flag F_{C} to 1 and sends it back to the band transfer controller 203.

On the other hand, when the server termination flag F_{S} indicates the termination of data processing of the band data expander 208 of the print server computer 101 (here, F_{S}−1), the band transfer controller 203 transfers the data of a band D_{B(j)} with band number j to the print server computer 101 through the interface circuit 206 (step S307).

In this manner, the steps S303-S307 are repeatedly performed until a selected band has reached the end of the page (step S308).

### Bit-Map Band Data Combination

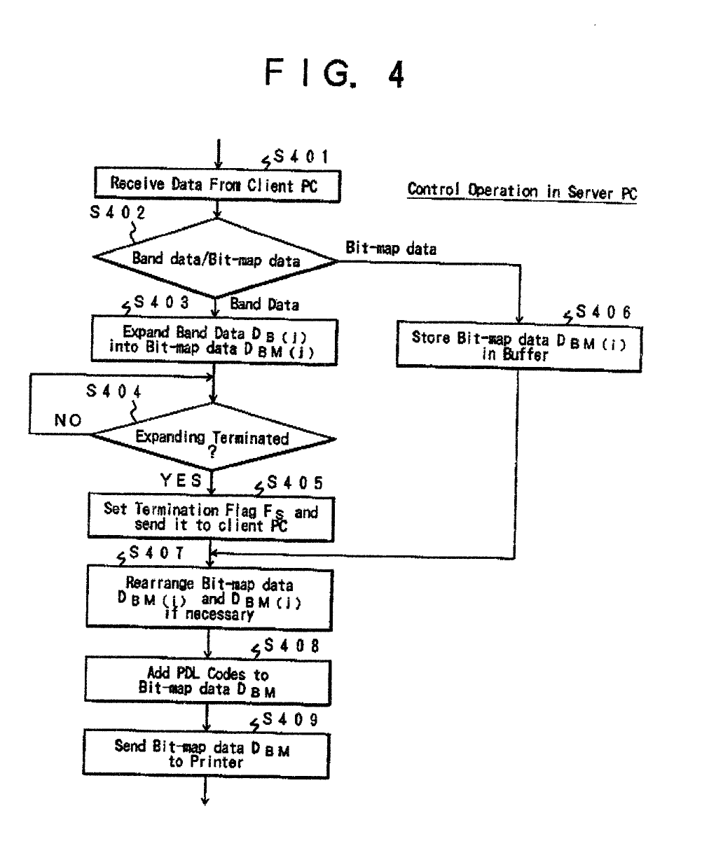

Referring to FIG. 4, when receiving data from the client computer PC (step 5401), it is determined whether it is band data or bit-map data (step S402). When the band data D_{B(j)} is received from the client computer PC, the band data expander 208 expands the band data to bit-map data D_{BM(j)} and stores it onto the band buffer 209 (step S403). During the data expanding operation, the server termination flag F_{S} is reset to 0. When the received band data has been completely expanded (YES in step S404), the band data expander 208 sets the server termination flag F_{S} to 1 and sends it back to the band transfer controller 203 of the client computer PC (step S405). When the bit-map data D_{BM(i)} is received from the client computer PC, it is stored onto the bit-map data buffer 211 (step S406).

The bit-map data D_{BM(i)} received from the client computer EC and the bit-map data D_{BM(j)} received from the band data expander 206 are rearranged according to their band numbers if necessary (step S407). Thereafter, PDL codes are added to the rearranged bit-map data for each page (step S408) and then the rearranged bit-map data with PDL codes is sent to the printer 102 through the communication buffer 103 (step S409).

### Second Embodiment

The present invention is not limited to the parallel data expanding between the print server computer 101 and the client computer PC as shown in FIG. 2. The print data divided into N bands may be expanded in parallel between one server computer and M client computers PC₁-PC_{M}, wherein M is an integer that is greater than 1 and not greater than the number N of bands.

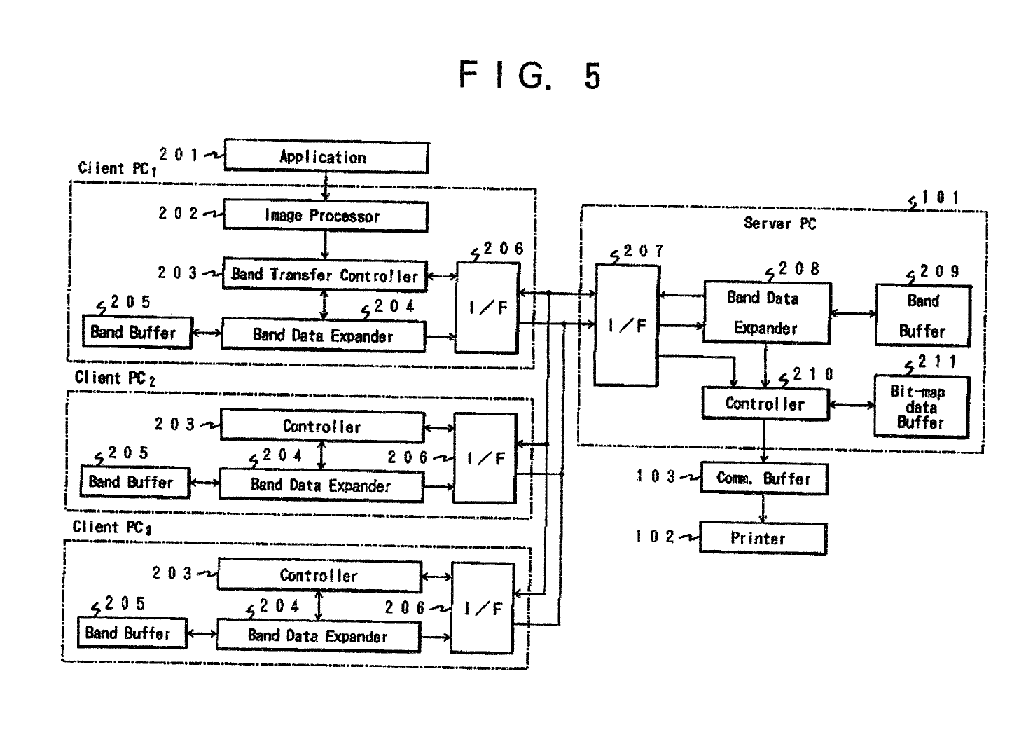

Referring to FIG. 5, assuming that at the client computer PC₁, the application 201 produces the print data, which are divided into the band data D_{B1}-D_{BN} by the image processor 202 as described before. In this embodiment, the client computers PC₁-PC₃ have the same circuit configuration and the functions of each client computer are similar to those of the client computer PC of FIG. 2. The client computers PC₁-PC₃ and the print server computer 101 are connected to form the client/server network system. The feature of the second embodiment resides in that each of the client computers PC₁-PC₃ can deliver the band data to the other client computers and the print server computer 101 to perform the parallel data expanding between them.

The band transfer controller 203 of the client computer PC₁ delivers the band data D_{B1}-D_{BN} in sequence to one of the band data expanders indicated by the same reference numeral 204 of the client computers PC₁-PC₃ and the band data expander 208 of the print server computer 101 depending on the termination flag received from each of the band data expanders.

More specifically, at the client computer PC₁, when receiving page print data including text data, graphic data and bit-map information from the application 201, the image processor 202 divides the page data into the numbered bands D_{B1}-D_{BN}. The band transfer controller 203 inputs one of the bands D_{B1}-D_{BN} in sequence and checks the client termination flags F_{C1}-F_{C3} and the server termination flag F_{S}. The respective client termination flags F_{C1}-F_{C3} are received from the band data expanders 204 of the client computers PC₁-PC₃ and the server termination flag F_{S} is received from the band data expander 208 of the print server computer 101.

In the case where the client termination flag F_{C1} indicates the termination of data processing of the band data expander 204 (here, F_{C1}=1), the band transfer controller 203 transfers the data of a band D_{B(i)} with band number i to the band data expander 204, which expands the band data to bit-map data D_{BM(i)} with band number i and stores it onto the band buffer 205. During the data expanding operation, the client termination flag F_{C1} is reset to 0. When the band data has been completely expanded, the band data expander 204 sets the client termination flag F_{C1} to 1 and sends it back to the band transfer controller 203. The bit-map data D_{BM(i)} with band number i is transferred from the band buffer 205 of the client computers PC₁ to the print server computer 101 through the network.

On the other hand, when the client termination flag F_{C2} or F_{C3} (hereinafter, described as F_{C2}/F_{C3}) indicates the termination of data processing at the client computer PC₂/PC₃ (here, F_{C2}/F_{C3}=1), the band transfer controller 203 of the client computer PC₁ transfers the data of a band D_{B(i)} with band number i to the client computer PC₂/PC₃, where the band data expander 204 expands the received band data to bit-map data D_{BM(i)} with band number i and stores it onto the band buffer 205. During the data expanding operation, the client termination flag F_{C2}/F_{C3} is reset to 0. When the band data has been completely expanded, the band data expander 204 of the client computer PC₂/PC₃ sets the client termination flag F_{C2}/F_{C3} to 1 and sends it back to the band transfer controller 203 of the client computer PC₁. The bit-map data D_{BM(i)} with band number i is transferred from the band buffer 205 of the client computer PC₂/PC₃ to the print server computer 101 through the network.

Similarly, when the server termination flag F_{S} indicates the termination of data processing of the band data expander 208 of the print server computer 101 (here, F_{S}=1), the band transfer controller 203 of the client computer PC₁ transfers the data of a band D_{B(j)} with band number j to the print server computer 101 through the interface circuit 206.

At the print server computer 101, when receiving data from the client computer, it is determined whether it is band data or bit-map data as shown in step S402 of FIG. 4. When the band data D_{B(j)} is received from the client computer PC₁, the band data expander 208 expands the band data to bit-map data D_{BM(j)} and stores it onto the band buffer 209. During the data expanding operation, the server termination flag F_{S} is reset to 0 and is sent back to the client computer PC₁ through the network. When the received band data has been completely expanded, the band data expander 208 sets the server termination flag F_{S} to 1 and sends it back to the band transfer controller 203 of the client computer PC₁. When the bit-map data D_{BM(i)} is received from one of the client computers PC₁-PC₃ it is stored onto the bit-map data buffer 211.

As described before, the bit-map data D_{BM(i)} are not always received in original sequence from the client computers PC₁-PC₃ due co difference in speed between the client computers PC₁-PC₃. Further, the bit-map data D_{BM(i)} and the bit-map data D_{BM(j)} are not always received in original sequence due to difference in speed between the client computers PC₁-PC₃ and the print server computer 101. Therefore, the bit-map data buffer 211 is used to rearrange the bit-map data of bands in original sequence by referring to the attached band numbers as described before.

### Third Embodiment

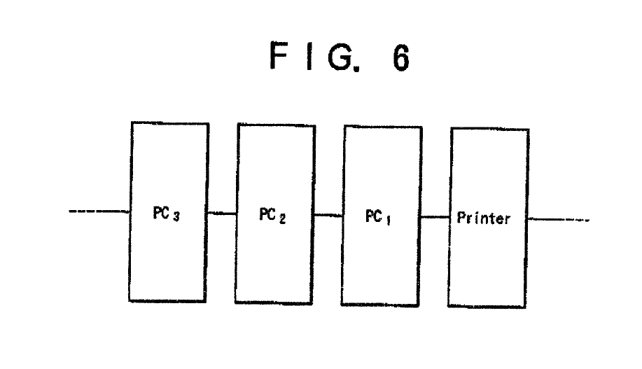

As shown in FIG. 6, the present invention can be applied to network printer system composed of a printer and a plurality of computers PC₁, PC₂, . . . . The printer is directly connected to the network system. In such a system, a computer causes other computers to be used to expand the print data in bands, The details will be described hereinafter.

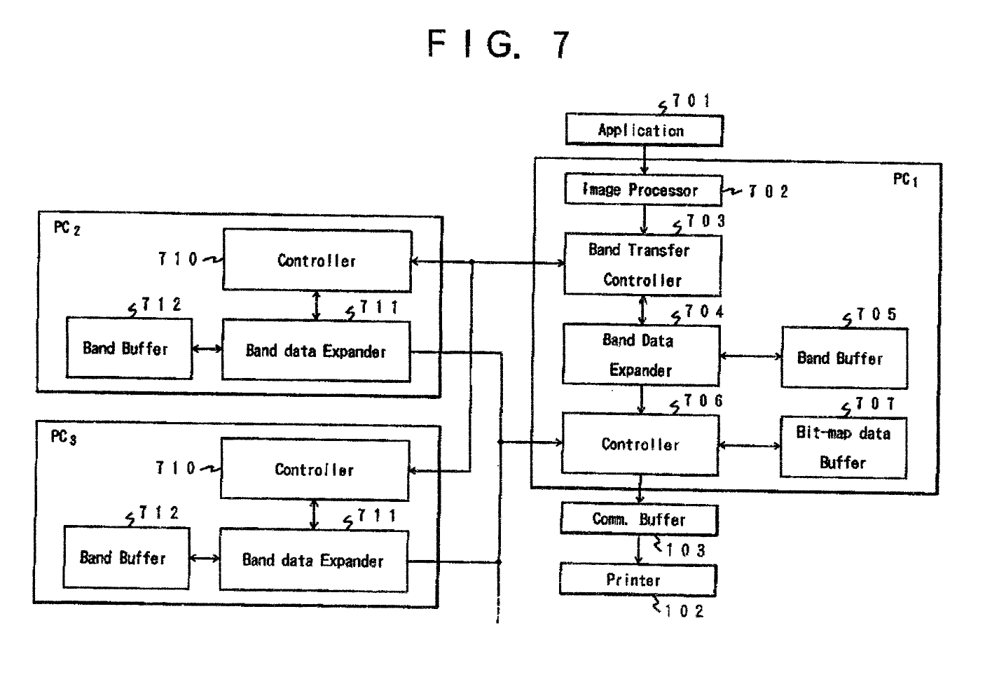

Referring to FIG. 7, the client computer PC₁ is connected to the printer 102 through the communication buffer 103. The client computer PC₁ is also connected to a plurality of computers PC₂, PC₃ . . . through a predetermined interface that is not shown in this figure for simplicity. In this embodiment, the computers PC₁-PC₃ have the same circuit configuration and the functions of each client computer are similar to those of the client computer PC of FIG. 2. The feature of the third embodiment resides in that each of the computers PC₁-PC₃ can deliver the band data to the other computers to perform the parallel data expanding between them and further can rearrange received bit-map data in original sequence to produce bit-map data for printing.

An application 701 produces the print data, which are divided into the band data D_{B1}-D_{BN} by an image processor 702 as described before. When sequentially receiving the respective band data D_{B1}-D_{BN} with band numbers from the image processor 702, a band transfer controller 703 determines which computer should expand each band data into bit-map data depending on termination flags received from the computers PC₂ and PC₃ and a band data expander 704.

More specifically, when the termination flag of the band data expander 704 indicates the termination of data processing, the band transfer controller 703 transfers the data of a band with band number to the band data expander 704. When the termination flag of the computer PC₂ indicates the termination of data processing, the band transfer controller 703 transfers the data of a band with band number to the computer PC₂. Similarly the termination flag of the computer PC₃ indicates the termination of data processing, the band transfer controller 703 transfers the data of a band with band number to the computer PC₃.

At the computer PC₁, when receiving the band data from the band transfer controller 703, the band data expander 704 expands the band data to bit-map data and stores it onto a band buffer 705. During the data expanding operation, the termination flag is reset. When the band data has been completely expanded, the band data expander 704 set the termination flag and sends it back to the band transfer controller 703.

A controller 706 receives the expanded bit-map data from the band data expander 704 and the computers PC₂ and PC₃ and stores the bit-map data from the computers PC₂ and PC₃ onto the bit-map data buffer 707. The controller 706 rearranges the received bit-map data in original sequence by referring to the attached band numbers as described before. In other words, the computer PC₁ includes the combined functions of the client and server computers as shown in FIGS. 3 and 4.

Each of the computers PC₂ and PC₃ is provided with a controller 710, a band data expander 711, a band buffer 712, and the predetermined interface circuit (not shown). The band data is received from the computer PC₁ and the termination flag is transmitted to the computer PC₁ through the predetermined interface. When the computer PC₂/PC₃ receives the band data from the computer PC₁, the band data expander 711 expands it to bit-map data, which is output to the computer PC₁. At the computer PC₁ the controller 706 rearranges the received bit-map data in original sequence by referring to the attached band numbers and outputs the bit-map data with PDL codes to the printer 102 through the communication buffer 103.

As described before, in the first embodiment as shown in FIG. 2, the band transfer controller 203, and the band data expander 204 in each client computer could be implemented with a program-controlled processor running the equivalent client control program. Similarly, in the server computer 101, the band expander 208 and the controller 210 could be implemented with a program-controlled processor running the equivalent server control program.

Referring to FIG. 8, the client computer PC₁ is provided with a control program memory 801 storing the programs of the above functions corresponding to the band transfer controller 203, and the band data expander 204 as shown in FIG. 3. Similarly, the print server computer 101 may be provided with a control program memory (not shown) storing the programs of the above functions corresponding to the band expander 208 and the controller 210 as shown in FIG. 4.

As described before, in the third embodiment as shown in FIG. 7, the band transfer controller 703, the band data expander 704 and the controller 706 in each computer could be implemented with a program-controlled processor running the equivalent client control program.

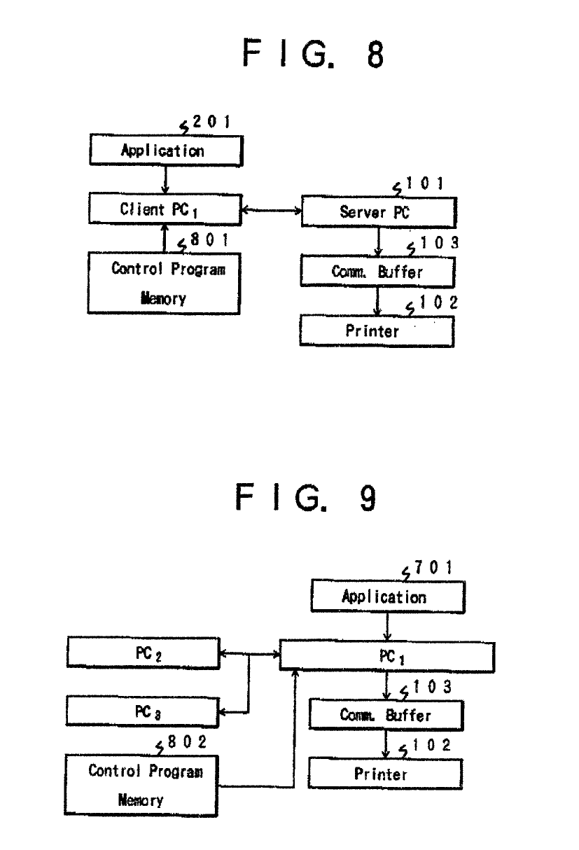

Referring to FIG. 9, the computer PC₁ is provided with a control program memory 802 storing the programs of the above functions corresponding to the band transfer controller 703, the band data expander 704 and the controller 706. Therefore, it can be said that the control program memory 802 stores the program combining programs as shown in FIGS. 3 and 4.

The control program memories 801 and 802 may be a magnetic disk, magneto-optic disk, semiconductor memory or the like.

What is claimed is:

1. A method for expanding print data to bit-map data in a network system composed off a plurality of computers, comprising the steps of:
a) dividing the print data into a plurality of bands;
b) transferring a sequentially selected one of the bands to an available one of at least two print data expanders each implemented in a computer;
c) expanding a received band to bit-map bard data in each of the at least two print data expanders; and
d) combining the bit-map band data expanded by the at least two print data expanders to produce the bit-map data corresponding to the print data.

2. The method according to claim 1, wherein the step b) comprises the steps of:
selecting one from the bands in sequence;
selecting one of the at least two print data expanders by checking a process status of each of the at least two print data expanders; and
transferring a selected band to a selected print data expander.

3. The method according to claim 1, wherein the step c) comprises the steps of:
expanding the received band to bit-map band data in each of the at least two print data expanders;
setting a process status of a print data expander to unavailable while expanding the received band; and
resetting the process status to available when the received band has been expanded.

4. The method according to claim 2, wherein the step c) comprises the steps of:
expanding the received band to bit-map band data in each of the at least two print data expanders;
setting the process status of a print data expander to unavailable while expanding the received band; and
resetting the process status to available when the received band has been expanded.

5. The method according to claim 1, wherein, in the step a), the print data is divided into the bands which are numbered from top of a page in sequence.

6. The method according to claim 5, wherein the step d) comprises the steps of:
receiving the bit-map band data from the at least two print data expanders;
determining whether the bit-map band data are received in original sequence of the bands;
rearranging the bit-map band data in the original sequence when a sequence of the bit-map band data is not identical to the original sequence; and
reproducing the bit-map data corresponding to the print data.

7. A network system composed of a plurality of computers, comprising:
a plurality of print data expanders each implemented in a computer, for expanding print data to bit-map data;
a page divider for dividing the print data for each page into a plurality of bands;
a band transfer controller for transferring a sequentially selected one of the bands to an available one of at least two print data expanders each implemented in a computer;
a combiner for combining bit-map band data expanded by the at least two print data expanders to produce the bit-map data corresponding to the print data.

8. The network system according to claim 7, wherein the band transfer controller selects one from the bands in sequence and one of the at least two print data expanders by checking a process status of each of the at least two print data expanders, and then transfers a selected band to a selected print data expander.

9. The network system according to claim 7, wherein each of the at least two print data expanders expands a received band to bit-map band data, sets a process status of a print data expander to unavailable while expanding the received bands and resets the process status to available when the received band has been expanded.

10. The network system according to claim 8, wherein each of the at least two print data expanders expands a received band to bit-map band data, sets a process status of a print data expander to unavailable while expanding the received band, and resets the process status to available when the received band has been expanded.

11. The network system according to claim 7, wherein the page divider divides the print data for each page into the bands which are numbered from top of a page in sequence.

12. The network system according to claim 11, wherein the combiner receives the bit-map band data f rom the at least two print data expanders, determines whether the bit-map band data are received in original sequence of the bands, rearranges the bit-map band data in the original sequence when a sequence of the bit-map band data is not identical to the original sequence, and reproducing the bit-map data corresponding to the print data.

13. A print data control method for a network system composed of a print server computer and a plurality of client computers, comprising the steps of:
a) dividing print data into a plurality of sequential bands;
b) distributing the sequential bands over the print server computer and at least one client computer to expand the sequential bands to bit-map band data in parallel among the print server computer and at least one client computer; and
c) combining the bit-map band data to produce the bit-map data corresponding to the print data.

14. The print data control method according to claim 13, wherein the step b) comprises the steps of:
at a client computer,
selecting one from the sequential bands in sequence;
selecting one of the print server computer and the client computer by checking process statuses thereof;
transferring a selected band to a selected computer;
expanding a received band to bit-map band data; and
setting a client process status of its own to unavailable while expanding the received band and resetting the client process status to available when the received band has been expanded, and
at the print server computer,
expanding a received band to bit-map band data; and
setting a server process status of its own to unavailable while expanding the received band and resetting the server process status to available when the received band has been expanded.

15. The print data control method according to claim 13, wherein the step c) comprises the steps of:
determining whether the bit-map band data are received in original sequence of the bands;
rearranging the bit-map band data in the original sequence when a sequence of the bit-map band data is not identical to the original sequence; and
reproducing the bit-map data corresponding to the print data.

16. A print data control method for a network system composed of a plurality of computers, comprising the steps of:
a) dividing print data into a plurality of sequential bands;
b) distributing the sequential bands over available computers to expand the sequential bands to bit-map band data in parallel among the available computers; and
c) combining the bit-map band data to produce the bit-map data corresponding to the print data.

17. The print data control method according to claim 16, wherein the step b) comprises the steps of:
at a first computer,
selecting one from the sequential bands in sequence;
selecting one of the computers by checking process statuses thereof;
transferring a selected band to a selected computer;
expanding a received hand to bit-map band data; and
setting a first process status to unavailable while expanding the received band and resetting the first process status to available when the received band has been expanded, and
at each of the computers other than the first computer,
expanding a received band to bit-map band data; and
setting a server process status of its own to unavailable while expanding the received band and resetting the server process status to available when the received band has been expanded.

18. The print data control method according to claim 17, wherein the first computer further combines the bit-map band data to produce the bit-map data corresponding to the print data.

19. The print data control method according to claim 16, wherein the step c) comprises the steps of:
determining whether the bit-map band data are received in original sequence of the bands;
rearranging the bit-map band data in the original sequence when a sequence of the bit-map band data is not identical to the original sequence; and
reproducing the bit-map data corresponding to the print data.

20. A storage storing a print data control program for use in a network system composed of a plurality of computers, the print data control program comprising the steps of:
a) dividing the print data into a plurality of bands;
b) transferring a sequentially selected one of the bands to an available one of at least two print data expanders each implemented in a computer;
c) expanding a received band to bit-map band data in each of the at least two print data expanders; and
d) combining the bit-map band data expanded by the at least two print data expanders to produce the bit-map data corresponding to the print data.
